(19) United States
(12) Patent Application Publication
(10) Pub. No.: US 2022/0300913 A1
(43) Pub. Date: Sep. 22, 2022

(54) MAINTENANCE SYSTEM, MAINTENANCE METHOD, AND STORAGE MEDIUM

(71) Applicant: HONDA MOTOR CO., LTD., Tokyo (JP)

(72) Inventors: Masaki Umezawa, Tokyo (JP); Naoto Koinuma, Tokyo (JP); Masaru Yatame, Tokyo (JP)

(73) Assignee: HONDA MOTOR CO., LTD., Tokyo (JP)

(21) Appl. No.: 17/673,225

(22) Filed: Feb. 16, 2022

(30) Foreign Application Priority Data
Mar. 16, 2021 (JP) 2021-042696

(51) Int. Cl. G06Q 10/00; G06Q 10/02; G06T 7/13; G06F 16/51; G06F 16/538; G06F 16/54

(52) U.S. Cl. CPC G06Q 10/20; G06Q 10/02; G06T 7/13; G06F 16/51; G06F 16/538; G06F 16/54

(57) ABSTRACT

A maintenance system is provided. A first acceptance unit accepts a registration request for an image for a maintenance report of a vehicle. A display control unit causes a display unit to display a registration screen having an image registration frame corresponding to a maintenance content based on acceptance of the registration request by the first acceptance unit.

### CROSS-REFERENCE TO RELATED APPLICATION(S)

This application claims priority to and the benefit of Japanese Patent Application No. 2021-042696 filed on Mar. 16, 2021, the entire disclosure of which is incorporated herein by reference.

### BACKGROUND OF THE INVENTION

### Field of the Invention

The present invention relates to a maintenance system, a maintenance method, and a storage medium.

### Description of the Related Art

As a system used for vehicle maintenance performed at a dealer, a maintenance factory, or the like, a system for inputting an inspection result using an inspection terminal, and outputting the inspection result by a host computer to present the inspection result to a customer is known (Japanese Patent No. 3522679).

### SUMMARY OF THE INVENTION

According to one embodiment of the present invention, a maintenance system comprises: a first acceptance unit configured to accept a registration request for an image for a maintenance report of a vehicle; and a display control unit configured to cause a display unit to display a registration screen having an image registration frame corresponding to a maintenance content based on acceptance of the registration request by the first acceptance unit.

According to another embodiment of the present invention, a maintenance method comprises: accepting a registration request for an image for a maintenance report of a vehicle; and causing a display unit to display a registration screen having an image registration frame corresponding to a maintenance content based on acceptance of the registration request in the accepting.

According to still another embodiment of the present invention, non-transitory storage medium stores a program causing a computer to execute a method, the method comprising: accepting a registration request for an image for a maintenance report of a vehicle; and causing a display unit to display a registration screen having an image registration frame corresponding to a maintenance content based on acceptance of the registration request in the accepting.

### BRIEF DESCRIPTION OF THE DRAWINGS

FIG. 1 is a diagram illustrating a configuration of a maintenance system according to an embodiment;

FIG. 2 is a flowchart illustrating a processing example of a processing unit of a server;

FIG. 3 is a flowchart illustrating a processing example of a processing unit of a terminal device;

FIG. 4 is a diagram illustrating a screen example displayed by a display unit;

FIG. 5 is a diagram illustrating a screen example displayed by a display unit;

FIG. 6 is a flowchart illustrating a processing example of a processing unit of a server and a processing unit of a terminal device;

FIG. 7 is a diagram illustrating a screen example displayed by a display unit;

FIG. 8 is a flowchart illustrating a processing example of a processing unit of a server and a processing unit of a terminal device;

FIG. 9A is a diagram illustrating a screen example displayed by a display unit;

FIG. 9B is a diagram illustrating a screen example displayed by a display unit;

FIG. 10 is a flowchart illustrating a processing example of a processing unit of a server and a processing unit of a terminal device of a customer; and

FIG. 11 is a diagram illustrating a screen example displayed by a display unit of a terminal device of a customer.

### DESCRIPTION OF THE EMBODIMENTS

When an inspection result is presented to a customer as a maintenance report, the maintenance report may be created using a photographed image of an inspection point so that the customer can more accurately grasp the state of the vehicle. In such a case, man-hours are required for arrangement, storage, and the like of the photographed images, and work efficiency may decrease.

Embodiments of the present invention provide a technique for efficiently creating a maintenance report using an image.

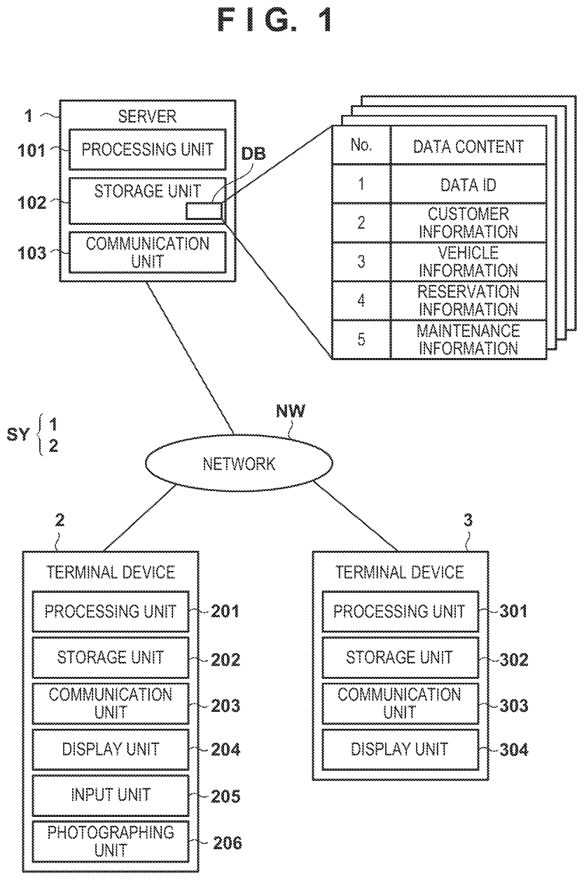

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

<1. System Configuration (FIG. 1)>

FIG. 1 is a diagram illustrating a configuration of a maintenance system SY according to an embodiment. The maintenance system SY is a system for performing maintenance of a vehicle in a dealer, a maintenance factory, or the like (hereinafter, these are collectively referred to as dealer). In the present embodiment, the maintenance system SY includes a server 1 and a terminal device 2, which are configured to be able to communicate with each other via a network NW such as the Internet. One or a plurality of terminal devices 2 may be installed for each dealer. The server 1 may be able to communicate with each terminal device 2 installed in each dealer. In the present embodiment, the server 1 of the maintenance system SY is configured to be able to communicate with a terminal device 3 of a customer via the network NW.

<1.1. Server 1>

The server 1 includes a processing unit 101, a storage unit 102, and a communication unit 103, which are connected by a bus (not illustrated). The processing unit 101 is a processor as typified by a CPU, and executes a program stored in the storage unit 102. The storage unit 102 is, for example, a read only memory (ROM), a random access memory (RAM), a hard disk drive (HDD), a solid state drive (SSD), or the like, and stores various data in addition to the program executed by the processing unit 101. The communication unit 103 is a communication interface with the terminal device 2 or the terminal device 3 which is an external device.

In the present embodiment, customer information database DB is constructed in the storage unit 102. In the customer information database DB, customer information, vehicle information, reservation information, and maintenance information are stored in association with data ID. In the present embodiment, the customer information is information related to a customer, and may include, for example, information such as a name, an address, a contact address, or a membership number as an identification number of the customer. The vehicle information is information related to a vehicle owned by the customer, and may include, for example, information such as a vehicle name, a model, a manufacturing number, and a manufacturing date. The reservation information is information related to a maintenance reservation to be described later, and may include, for example, information such as a reservation date and time, a reserved store, and a work content. The maintenance information is information related to past maintenance contents and the like, and may include, for example, information such as an implementation history of a vehicle inspection, a periodic inspection, or the like, a maintenance history, a replacement history of a consumable part, and the like.

<1.2. Terminal Device 2>

The terminal device 2 is an information processing terminal provided in a dealer, and is, for example, a tablet or a notebook computer. The terminal device 2 includes a processing unit 201, a storage unit 202, and a communication unit 203, which are connected by a bus (not illustrated). The processing unit 201 is a processor as typified by a CPU, and executes a program stored in the storage unit 202. The storage unit 202 is, for example, a read only memory (ROM), a random access memory (RAM), a hard disk drive (HDD), a solid state drive (SSD), or the like, and stores various data in addition to the program executed by the processing unit 201. The communication unit 203 is a communication interface with the server 1 or the like which is an external device.

The terminal device 2 includes a display unit 204, an input unit 205, and a photographing unit 206. The display unit 204 displays various user interface screens. The display unit 204 may be a liquid crystal display, an organic EL display, or the like. The input unit 205 accepts an input by a user. The input unit 205 may be a pointing device such as a touch panel or a mouse, or a hard key such as a keyboard. The photographing unit 206 is, for example, a camera, and can photograph a vehicle, components thereof, and the like at the time of maintenance. The photographing unit 206 may be provided separately from the terminal device 2. For example, the photographing unit 206 is a photographing device such as a digital camera, and may be capable of transmitting a photographed image to the terminal device 2 by wired or wireless communication.

<1.3. Terminal Device 3>

The terminal device 3 is an information processing terminal owned by a customer, and may be, for example, a smartphone, a tablet, or a personal computer. The terminal device 3 includes a processing unit 301, a storage unit 302, and a communication unit 303, which are connected by a bus (not illustrated). The processing unit 301 is a processor as typified by a CPU, and executes a program stored in the storage unit 302. The storage unit 302 is, for example, a read only memory (ROM), a random access memory (RAM), a hard disk drive (HDD), a solid state drive (SSD), or the like, and stores various data in addition to the program executed by the processing unit 301. The communication unit 303 is a communication interface with the server 1 or the like which is an external device. The terminal device 3 includes a display unit 304 such as a liquid crystal display or an organic EL display that displays various user interface screens.

The functions implemented by the processing unit 101, the processing unit 201, or the processing unit 301 may be realized by either hardware or software. For example, the functions of the processing unit 101, the processing unit 201, or the processing unit 301 may be realized by the CPU executing a predetermined program using a memory as described above. Alternatively, at least a part of the functions of the processing unit 101, the processing unit 201, or the processing unit 301 may be realized by a known semiconductor device such as a programmable logic device (PLD) or an application specific integrated circuit (ASIC). Here, the processing unit 101, the processing unit 201, or the processing unit 301 is illustrated as a single element, but these may be divided into two or more elements as necessary.

<2. Operation Example of Maintenance System SY>

An operation example of the maintenance system SY will be described. First, the maintenance system SY accepts a maintenance reservation from a customer. For example, when a reservation request is transmitted from the terminal device 3 to the server 1, the processing unit 101 accepts the reservation and stores the information in the customer information database DB. Alternatively, when a customer calls a person in charge at a dealer to make a reservation, the person in charge at the dealer transmits information related to the reservation from the terminal device 2 to the server 1, and the information received by the processing unit 101 of the server 1 is stored in the customer information database DB.

Next, when the customer comes to the dealer at the reservation date and time, the person in charge at the dealer implements maintenance of the customer's vehicle. At that time, the person in charge performs work while photographing the state of the vehicle with the terminal device 2. Although details will be described later, the person in charge performs work while registering the photographed image on a registration screen (format) corresponding to the maintenance content. After the work, the person in charge creates a report using the image photographed during the work by the terminal device 2. Then, the person in charge reports the result of maintenance to the customer using the report created by the terminal device 2.

By using the maintenance system SY, the person in charge can easily grasp the photographed image necessary for the report by registering the photographed image along the registration screen. Therefore, the person in charge can easily create the report including the necessary photographed image. Hereinafter, a specific processing example of each component when the maintenance system SY is operated will be described.

<3. Processing Example>

<3.1. Reservation Acceptance Processing>

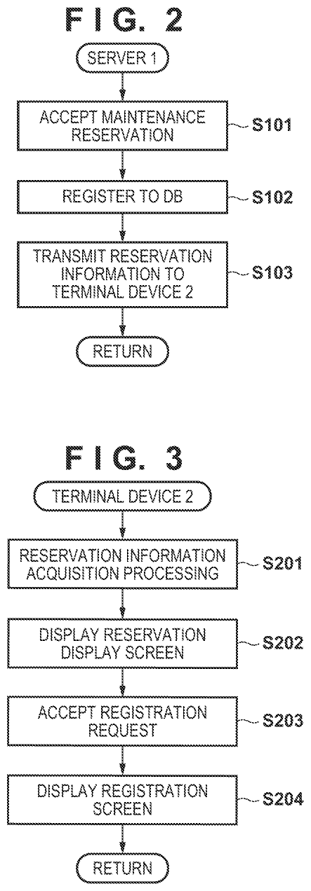

FIG. 2 is a flowchart illustrating a processing example of the processing unit 101 of the server 1. FIG. 2 illustrates an example of reservation acceptance processing by the processing unit 101. Each step of this flowchart is realized, for example, by the processing unit 101 reading and executing a program stored in the storage unit 102. This flowchart may be repeatedly executed at a predetermined cycle.

In step S101 (hereinafter, each step is simply referred to as S101 or the like), the processing unit 101 accepts a maintenance reservation from a customer. Specifically, the processing unit 101 accepts information related to maintenance reservation transmitted from the terminal device 3 via the communication unit 103. The information related to the maintenance reservation may include, for example, a desired date and time, a store name, customer information, or vehicle information. When the customer makes a reservation to a person in charge at the dealer by telephone or the like, the person in charge at the dealer inputs information related to the maintenance reservation to the terminal device 2, and the processing unit 101 accepts the information transmitted from the terminal device 2.

In S102, the processing unit 101 registers the received information related to the maintenance reservation in the customer information database DB.

In S103, the processing unit 101 transmits the reservation information to the terminal device 2. In a case where the server 1 is able to communicate with the terminal devices 2 provided in a plurality of stores, the server 1 may transmit the reservation information to the terminal device 2 provided in the store to be reserved.

<3.2. Registration Screen Display Processing>

FIG. 3 is a flowchart illustrating a processing example of the processing unit 201 of the terminal device 2. FIG. 3 illustrates an example of registration screen display processing by the processing unit 201. Each step of this flowchart is realized, for example, by the processing unit 201 reading and executing a program stored in the storage unit 202. This flowchart is executed, for example, after an application of a maintenance system installed in the terminal device 2 is activated and predetermined processing such as user authentication is performed.

In S201, the processing unit 201 executes reservation information acquisition processing. Specifically, the processing unit 201 acquires the information transmitted from the processing unit 101 in S103 of FIG. 2 and stored in the storage unit 202. Alternatively, the processing unit 201 may request reservation information to the server 1. Then, the processing unit 101 of the server 1 may transmit the reservation information stored in the customer information database DB to the terminal device 2 on the basis of the reception of the reservation information request from the terminal device 2.

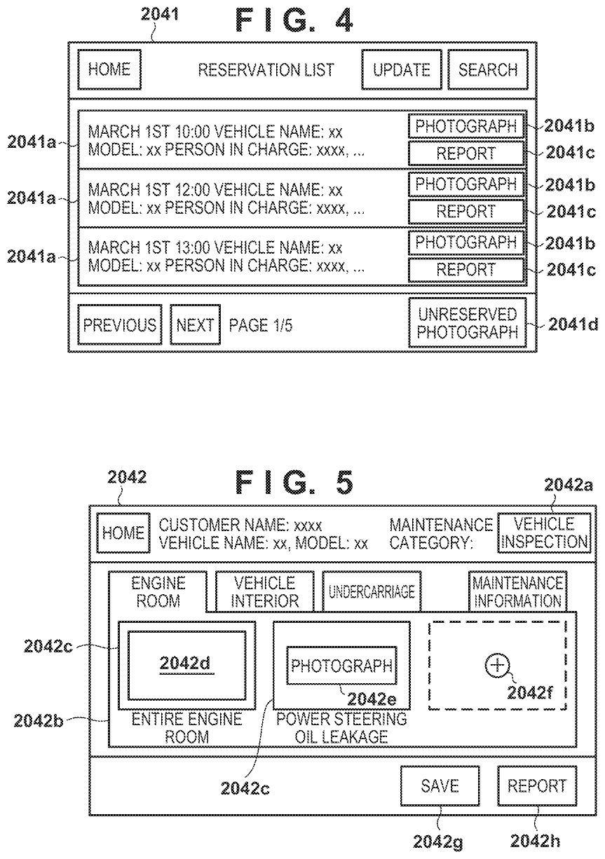

In S202, the processing unit 201 causes the display unit 204 to display a reservation display screen 2041. FIG. 4 is a view illustrating a screen example displayed by the display unit 204, and illustrates the reservation display screen 2041 as the screen example. In the present embodiment, the reservation display screen 2041 is a screen for displaying a reservation related to maintenance, and for example, a list of reservations of the day is displayed. On the reservation display screen 2041, three maintenance reservations 2041a are displayed, and information such as a reservation date and time, a vehicle name, a model, and a name of a person in charge is included. The information included in the column of the maintenance reservation 2041a includes information on the maintenance reservation received by the processing unit 101 in S101, information acquired from the customer information database DB, or the like. That is, the processing unit 201 can cause the display unit 204 to display the reservation display screen 2041 including the information on the maintenance reservation received by the processing unit 101.

In addition, on the reservation display screen 2041, one maintenance reservation 2041a can be selected from a plurality of the maintenance reservations 2041a. Here, a photographing start button 2041b and a report generation button 2041c are provided in an area showing each maintenance reservation 2041a. One of these buttons is selected by the input unit 205, whereby one maintenance reservation 2041a is selected from the plurality of the maintenance reservations 2041a. The photographing start button 2041b is a button for transitioning to a registration screen 2042 (FIG. 5) to be described later, and the report generation button 2041c is a button for generating a report and transitioning to a report check screen 2043 (FIG. 7) to be described later. On the reservation display screen 2041, an unreserved photographing button 2041d is provided. The unreserved photographing button 2041d is a button for transitioning to the registration screen 2042 (FIG. 5) to be described later, for example, in a case where unexpected maintenance without maintenance reservation occurs.

In S203, the processing unit 201 accepts a registration request of an image for a maintenance report of the vehicle. Specifically, the processing unit 201 accepts, via the input unit 205, a request regarding display of the registration screen 2042 for registering a photographed image in the maintenance system SY by the user (the person in charge at the dealer). In the present embodiment, when the photographing start button 2041b on the reservation display screen 2041 is selected, the processing unit 201 recognizes that the registration request is received. That is, the registration request can be said to be a request for the target vehicle of the maintenance reservation received by the processing unit 101 in S101. From the viewpoint that the plurality of maintenance reservations 2041a are displayed on the reservation display screen 2041, it can be said that the registration request is a request for the target vehicle of one maintenance reservation 2041a selected from the plurality of the maintenance reservations 2041a on the reservation display screen 2041.

In S204, the processing unit 201 displays the registration screen 2042. FIG. 5 is a diagram illustrating a screen example displayed by the display unit 204, and illustrates the registration screen 2042 as the screen example. In a header portion of the registration screen 2042, a customer name, a vehicle name, and a model are displayed. In addition, customer information, vehicle information, and the like may be appropriately displayed in the header portion. In addition, in the header portion is provided with a maintenance category field 2042a. In this screen example, “vehicle inspection” is displayed in the maintenance category field 2042a. This indicates that the maintenance category is the vehicle inspection, and contents corresponding to the vehicle inspection are displayed in a body portion of the registration screen 2042. The maintenance categories may include legal inspections such as 12 month inspections and 24 month inspections in addition to the vehicle inspection.

The body portion of the registration screen 2042 is provided with an individual part display unit 2042b. The individual part display unit 2042b is provided with an image registration frame 2042c. In the individual part display unit 2042b, the image registration frame 2042c is arranged for each part of a vehicle. The target part may include at least one of an engine, a vehicle interior, or an undercarriage. In this example, the individual part display unit 2042b of an engine room is displayed. However, for example, when a vehicle interior tab is selected by the input unit 205, the individual part display unit 2042b in which the image registration frame 2042c for a vehicle interior is arranged is displayed.

The image registration frame 2042c is a frame for registering a photographed image. In this example, a registered image 2042d of the engine room is registered in the image registration frame 2042c on the left side. The image registration frame 2042c at the center is a frame for registering the registered image 2042d for checking the power steering oil leakage, but is in a state before the registered image 2042d is registered in this example.

A photographing button 2042e is provided in the image registration frame 2042c before the registered image 2042d is registered. When the photographing button 2042e is selected by the input unit 205, the processing unit 201 activates an application for photographing by the photographing unit 206. When the photographing is performed by the photographing unit 206, the processing unit 201 registers the photographed image as the registered image 2042d in the image registration frame 2042c. The image registration frame 2042c before the registered image 2042d is registered may be provided with a button or the like for opening a folder in order to select an image stored in the storage unit 202. In a case where the photographing unit 206 is provided separately from the terminal device 2, in a case where the registration screen 2042 is displayed after photographing by the photographing unit 206 is performed in advance, or the like, the registered image 2042d may be registered in the image registration frame 2042c by selecting an image stored in the storage unit 202.

The individual part display unit 2042b is provided with an add button 2042f In a case where a photographed image other than the content already prepared as the image registration frame 2042c is registered, the user (the person in charge at the dealer) selects the add button 2042f by the input unit 205. The processing unit 201 generates a new image registration frame 2042c on the basis of selection of the add button 2042f This allows the user (the person in charge at the dealer) to register an image for a unique inspection item, or to additionally register an image of a particularly severely deteriorated portion or the like.

A footer portion of the registration screen 2042 is provided with a save button 2042g and a report generation button 2042h. The save button 2042g is a button for saving the registered image 2042d. When the save button 2042g is selected by the input unit 205, the registered image 2042d is stored in the storage unit 202 of the server 1 by processing to be described later. The report generation button 2042h is a button for generating a maintenance report using the registered image 2042d. Generation of the maintenance report will be described later.

Here, in the present embodiment, the processing unit 201 causes the display unit 204 to display the registration screen 2042 having the image registration frame 2042c corresponding to the maintenance content on the basis of the reception of the registration request in S203. Specifically, the processing unit 201 determines the items of the image registration frame 2042c included in the registration screen 2042 on the basis of the information on the maintenance content of the target vehicle for which the registration request has been received, included in the information acquired in S201. This allow the registration screen having the image registration frame corresponding to the maintenance content to be displayed, and therefore it is possible to efficiently create a maintenance report using an image.

The maintenance content may include information on a maintenance category, and the maintenance category may include at least one of a vehicle inspection or a legal inspection. For example, the processing unit 201 may vary the image registration frame 2042c to be displayed between when the maintenance category is a vehicle inspection and when the maintenance category is a legal inspection.

In addition, the processing unit 201 may cause the display unit 204 to display the registration screen 2042 having the image registration frame 2042c corresponding to vehicle type and maintenance content of the vehicle. The processing unit 201 may vary the image registration frame 2042c to be displayed on the basis of the model and manufacture year of the vehicle, other specifications, and the like. The processing unit 201 can acquire these pieces of information from the customer information database DB of the server 1.

The maintenance content may be different depending on a difference in vehicle type and a difference in maintenance category such as vehicle inspection and legal inspection, and the kind of image required for the report may also be different accordingly. The processing unit 201 can display an appropriate registration screen 2042 by setting the image registration frame 2042c according to the vehicle type and maintenance content of the vehicle.

In a case where the unreserved photographing button 2041d is selected on the reservation display screen 2041, the processing unit 201 may first cause the display unit 204 to display a screen for inputting a vehicle type, a repair content, and the like. Then, the processing unit 201 may cause the display unit 204 to display the registration screen 2042 having the image registration frame 2042c corresponding to the vehicle type and maintenance content input to the screen. This allows an appropriate registration screen 2042 to be displayed even in an unexpected maintenance without maintenance reservation or the like.

<3.3. Report Generation Processing>

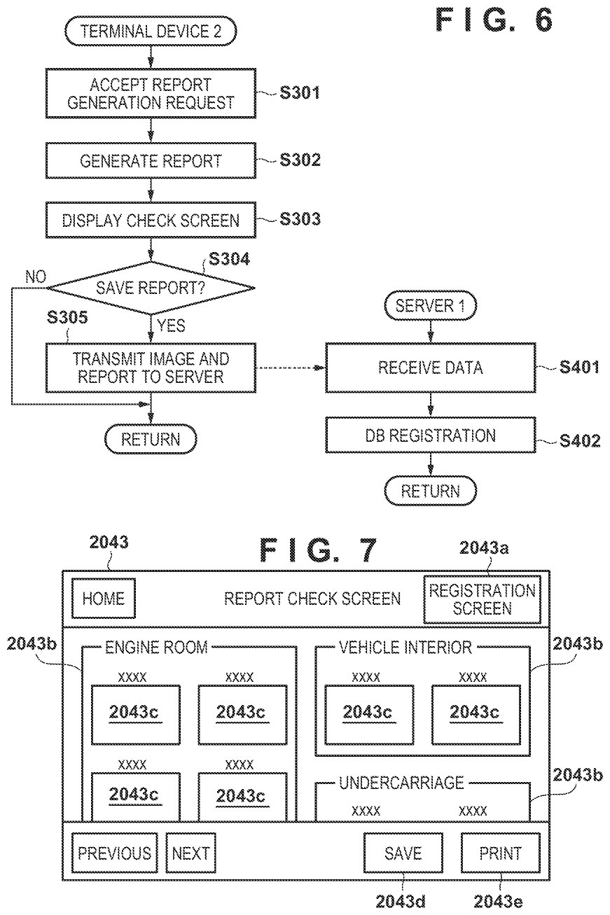

FIG. 6 is a flowchart illustrating a processing example of the processing unit 101 of the server 1 and the processing unit 201 of the terminal device 2. FIG. 6 illustrates an example of report generation processing. This flowchart is executed, for example, when an application of a maintenance system installed in the terminal device 2 is activated.

In S301, the processing unit 201 accepts a report generation request. For example, when the report generation button 2041c of FIG. 4 or the report generation button 2042h of FIG. 5 is selected by the input unit 205, the processing unit 201 recognizes that the report generation request has been received.

In S302, the processing unit 201 generates a report. Specifically, the processing unit 201 uses the registered image 2042d registered on the registration screen 2042 to generate a maintenance report in which a maintenance result can be checked by an image.

In S303, the processing unit 201 displays a check screen of the generated report. FIG. 7 is a diagram illustrating a screen example displayed by the display unit 204, and illustrates the report check screen 2043 as the screen example. A header portion of the report check screen 2043 is provided with a registration screen button 2043a, and when the registration screen button 2043a is selected by the input unit 205, the processing unit 201 causes the display of the display unit 204 to transition from the report check screen 2043 to the registration screen 2042.

A body portion of the report check screen 2043 is provided with an individual part display frame 2043b, and a registered image 2043c of the target part is arranged side by side in the individual part display frame 2043b. In this example, frames for an engine room, a vehicle interior, and an undercarriage are provided as the individual part display frame 2043b.

In addition, a footer portion of the report check screen 2043 is provided with a save button 2043d and a print button 2043e. The save button 2043d is a button for saving the generated report. The print button 2043e is a button for printing the generated report. The processing unit 201 can cause a printer or the like to print the report by transmitting a print job to the printer or the like (not illustrated) that can communicate via the network NW.

In S304, the processing unit 201 checks whether or not to save the report, proceeds to S305 when saving the report, and ends the flowchart when not saving the report. For example, when the input unit 205 selects the save button 2043d, the processing unit 201 proceeds to S305, and when the input unit 205 selects the registration screen button 2043a, a button for transitioning to another screen, or the like, the flowchart ends.

In S305, the processing unit 201 transmits the image and report to the server 1. Specifically, the processing unit 201 transmits the registered image 2042d registered on the registration screen 2042 and the data of the report generated in S302 to the server 1 by the communication unit 203.

In S401, the processing unit 101 of the server 1 receives the data transmitted from the terminal device 2 in S305.

In S402, the processing unit 101 registers the received data in the customer information database DB. In the present embodiment, the processing unit 101 stores the registered image 2042d registered in the image registration frame 2042c on the registration screen 2042 in association with the customer information of the vehicle in the storage unit 102. That is, the processing unit 101 stores the registered image 2042d and the customer information of the vehicle in association with each other by registering the registered image 2042d in the customer information database DB as the maintenance information. This allows the registered image 2042d or the report to be referred to when there is a browsing request from the customer or when the dealer implements the next maintenance or the like.

<3.4. Replacement Determination Processing>

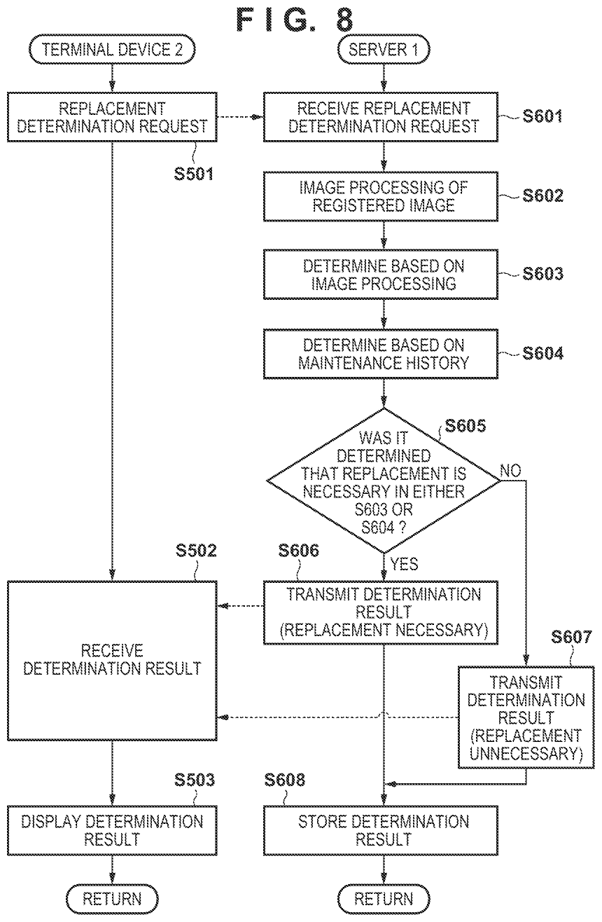

FIG. 8 is a flowchart illustrating a processing example of the processing unit 101 of the server 1 and the processing unit 201 of the terminal device 2. FIG. 8 illustrates an example of replacement determination processing. In the present embodiment, the replacement determination process is a processing of determination related to replacement of a consumable part such as an engine oil or a filter using the registered image 2042d registered on the registration screen 2042.

In S501, the processing unit 201 transmits a replacement determination request to the server 1. In the present embodiment, the replacement determination request is a request for determination related to replacement of a consumable part using the registered image 2042d registered on the registration screen 2042. For example, the processing unit 101 may be configured to be able to transmit the replacement determination request to the server 1 on an application of a maintenance system installed in the terminal device 2.

In S601, the processing unit 101 receives the replacement determination request transmitted from the processing unit 201.

In S602, the processing unit 101 executes image processing on the registered image 2042d registered on the registration screen 2042. Thereafter, in S603, the processing unit 101 makes a determination related to replacement of a consumable part based on the image processing.

For the image processing and the determination based on the image processing, known techniques may be appropriately adopted. For example, the processing unit 101 performs edge detection processing on the photographed image of an oil level gauge. Then, the oil level may be estimated by the edge detection processing, and it may be determined whether an oil replacement is necessary or not based on the estimated value. More specifically, assuming that the maximum value of the color difference in the measurement region is 100%, the processing unit 101 may recognize a position where the ratio of the value of the color difference to the maximum value of the color difference is equal to or larger than a threshold as the edge.

The processing unit 101 may determine the time when the oil replacement is necessary when it is determined that the oil replacement is unnecessary at the present stage. The processing unit 101 calculates a decrease amount of the oil level from the oil level based on the photographed image at the previous maintenance and the current oil level. Then, the processing unit 101 may determine the time when the oil replacement is necessary on the basis of the current oil level, the decrease amount of the oil level, the elapsed period from the previous maintenance to the present, the travel distance of the vehicle, and the like.

Another example of the image processing and the determination based on the image processing includes determination of replacement of an air cleaner element using binarization processing. The processing unit 101 performs binarization processing on a photographed image of the air cleaner element to convert the photographed image into two kinds of black and white pixels. More specifically, the processing unit 101 converts the photographed image of the air cleaner element into a monochrome image, and converts a specific concentration range into white and the outside of the range into black. The specific concentration range here can be set to a concentration range in which the air cleaner element can be continuously used. Then, the processing unit 101 may determine that replacement of the air cleaner element is necessary when the ratio of black pixels is equal to or more than a threshold value. The processing unit 101 may also determine the time when a replacement of the air cleaner element is necessary on the basis of the current ratio of black pixels, the increase amount in the ratio of black pixels from the previous maintenance to the current maintenance, the elapsed period from the previous maintenance to the present, the travel distance of the vehicle, and the like.

Furthermore, another example of the image processing and the determination based on the image processing includes a replacement determination using character recognition such as optical character recognition (OCR). For example, an expiration date, an expiration date, or the like may be printed on a smoke pot or a puncture repair kit mounted on a vehicle. The processing unit 101 may determine whether replacement is necessary or not by detecting these expiration dates from the registered image 2042d.

In S604, the processing unit 101 makes a determination on replacement of a consumable part based on the use history. Replacement timing of a consumable part such as an engine oils or an air cleaner element may be specified based on a use period, a travel distance, and the like. Therefore, the processing unit 101 may determine whether replacement of a consumable part is necessary or not on the basis of the usage condition of the vehicle since the last replacement of the consumable part.

In S605, the processing unit 101 checks whether or not it is determined that replacement is necessary in either S603 or S604, proceeds to S606 if it is determined that replacement is necessary in either S603 or S604, and proceeds to S606 if it is determined that replacement is unnecessary in both S603 and S604.

In S606, the processing unit 101 transmits a determination result that replacement of the consumable part is necessary to the processing unit 201. In a case where the processing proceeds to S607, the processing unit 101 transmits a determination result that replacement of the consumable part is unnecessary to the processing unit 201. The processing unit 101 may transmit information on the scheduled replacement date when the time is determined in S603 when replacement becomes necessary.

In S608, the processing unit 101 stores the registered image 2042d and the customer information and the determination result in S603 in the storage unit 102 in association with each other. Specifically, the processing unit 101 registers the determination result in S603 as the maintenance information in the customer information database DB.

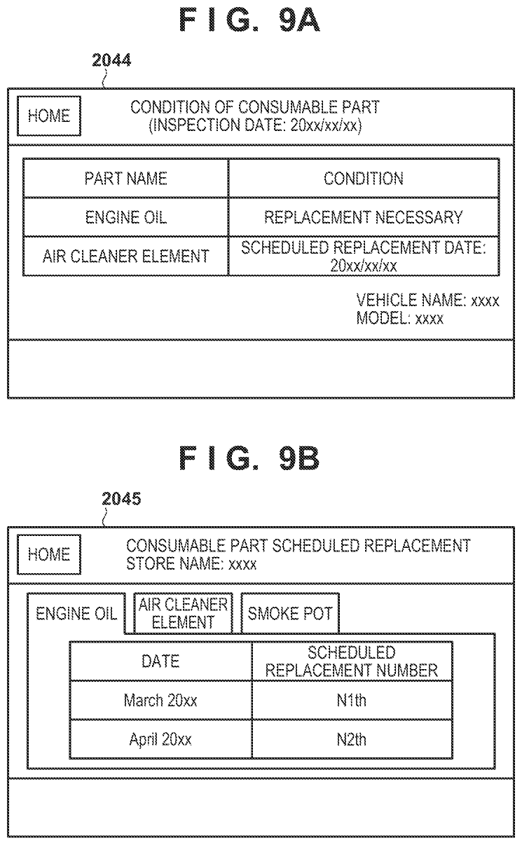

In S502, the processing unit 201 receives the result of replacement determination from the processing unit 101. In S503, the processing unit 201 causes the display unit 204 to display the received determination result. FIG. 9A is a diagram illustrating a screen example displayed by the display unit 204, and illustrates a consumable part condition check screen 2044 as the screen example. This screen can be presented, for example, when the person in charge at the dealer explains the condition of the consumable part to the customer after the maintenance of the vehicle is finished. In the example of the diagram, it is shown that replace of the engine oil is necessary. For the air cleaner element, because replacement is unnecessary at the present stage, a scheduled replacement date is shown.

The determination result of the replacement time of a consumable part can be used when each store of the dealer performs inventory management and the like of the consumable part. FIG. 9B is a diagram illustrating a screen example displayed by the display unit 204, and illustrates a scheduled replacement date screen 2045 as the screen example. Specifically, the determination result in S603 is stored in the customer information database DB as the maintenance information, and this information and the store information of the dealer may be stored in the storage unit 102 in association with each other. Then, for each store, how many of which consumable part is required in which month may be calculated and stored in the storage unit 102. The processing unit 201 may acquire these pieces of information from the server 1 and causes the display unit 204 to display the information. The information in which the store information and the information on the necessary number of a consumable part are in association with each other may be managed by a database constructed separately from the customer information database DB in the storage unit 102, or may be managed by a server or the like different from the server 1.

<3.5. Replacement Information Browsing Processing>

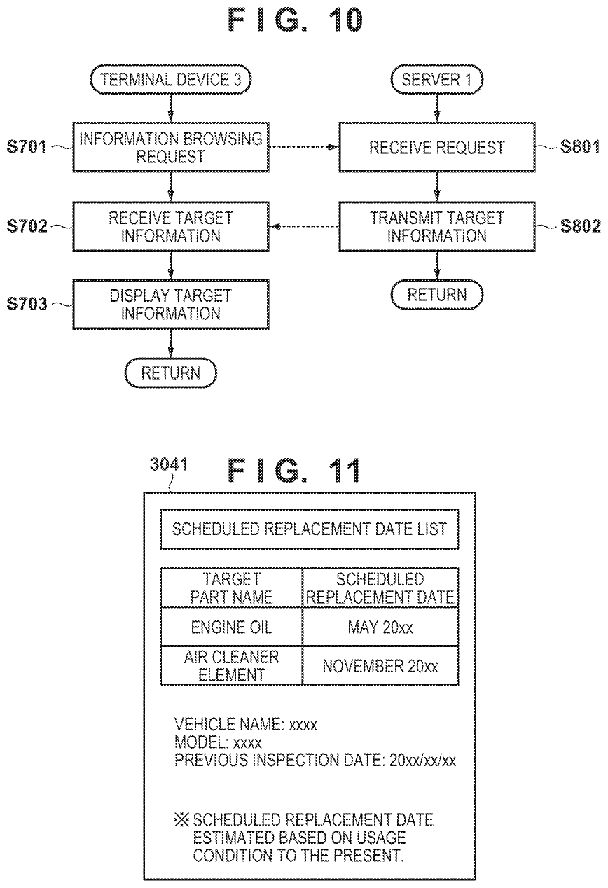

FIG. 10 is a flowchart illustrating a processing example of the processing unit 101 of the server 1 and the processing unit 301 of the terminal device 3. FIG. 10 illustrates an example of replacement information browsing processing. This flowchart starts, for example, when a browsing request for an image at the time of maintenance of a vehicle or information related to replacement of a consumable part is selected in an application for browsing vehicle information installed in the terminal device 3.

In S701, the processing unit 301 transmits an information browsing request to the processing unit 101. Specifically, the processing unit 101 transmits a request for browsing a photographed image at the time of maintenance of the vehicle used by the customer, information on a scheduled replacement date or the like of a consumable part mounted on the vehicle, or the like.

In S801, the processing unit 101 receives the information browsing request from the processing unit 101 of the terminal device 3 of the customer. That is, the processing unit 101 receives a browsing request for a photographed image at the time of maintenance of the vehicle used by the customer, a maintenance report using the photographed image, or information on a scheduled replacement date or the like of a consumable part mounted on the vehicle.

In S802, the processing unit 101 transmits target information. In a case where the browsing request is a browsing request for a photographed image at the time of maintenance of the vehicle, that is, the registered image 2042d, the processing unit 101 transmits the registered image 2042d registered in the customer information database DB to the terminal device 3. In a case where the browsing request is a browsing request for the determination result on replacement of a consumable part, for example, a browsing request for information on the replacement time, the processing unit 101 transmits information on the determination result registered in the customer information database DB to the terminal device 3.

In S702, the processing unit 301 receives target information. In S703, the processing unit 301 causes the display unit 304 to display the received target information. FIG. 11 is a diagram illustrating a screen example displayed by the display unit 304, and illustrates a replacement schedule check screen 3041 as the screen example. The scheduled replacement date of each consumable part of the vehicle owned by the customer is displayed on the replacement schedule check screen 3041. This allows the customer to easily grasp the scheduled replacement date of the consumable part. In a case where the browsing request is a browsing request for a photographed image at the time of maintenance of the vehicle, that is, the registered image 2042d, the processing unit 101 may transmit the report generated in S302 to the terminal device 3 in S802.

As described above, according to the present embodiment, because the registration screen 2042 having the image registration frame 2042c corresponding to the maintenance content is displayed, it is possible to efficiently create a maintenance report using an image.

<4. Modification Examples>

In the above embodiment, the display of the display unit 204 transitions from the reservation display screen 2041 to the registration screen 2042, but an embodiment in which the registration screen 2042 is displayed without the information on the maintenance reservation can also be adopted. For example, the processing unit 101 may cause the display unit 204 to display a format in which information such as a vehicle type and model of the vehicle to be maintained and information on maintenance category can be input. Then, the processing unit 101 may determine the maintenance content based on the information input to the format by the input unit 205 and cause the display unit 204 to display the registration screen 2042 corresponding to the maintenance content.

In the above embodiment, the maintenance system SY is configured by the server 1 and the terminal device 2, but the maintenance system SY may be configured by a single device. Furthermore, at least a part of the processing executed by the server 1 in the above embodiment may be executed by the terminal device 2, or at least a part of the processing executed by the terminal device 2 may be executed by the server 1.

<5. Summary of Embodiment>

The above embodiment discloses at least the following maintenance system, maintenance method, and program.

1. A maintenance system in the above embodiment comprises:

a first acceptance unit (201, S203) configured to accept a registration request for an image for a maintenance report of a vehicle; and

a display control unit (201, S204) configured to cause a display unit (204) to display a registration screen (2042) having an image registration frame (2042c) corresponding to a maintenance content based on acceptance of the registration request by the first acceptance unit.

According to this embodiment, because the registration screen having the image registration frame corresponding to the maintenance content is displayed, it is possible to efficiently create a maintenance report using an image.

2. According to the above embodiments, the maintenance system further comprises:

a second acceptance unit (101, S101) configured to accept a maintenance reservation,

wherein the registration request is a request for a target vehicle of the maintenance reservation accepted by the second acceptance unit.

According to this embodiment, it is possible to display the registration screen corresponding to the maintenance content of the vehicle for which the maintenance reservation has been made.

3. According to the above embodiments,

the display control unit is capable of causing the display unit to display a reservation display screen (2041) including information on a plurality of the maintenance reservations accepted by the second acceptance unit,

the reservation display screen allows selection of one maintenance reservation from the plurality of the maintenance reservations, and

the registration request is a request for the target vehicle of the one maintenance reservation selected from the plurality of the maintenance reservations on the reservation display screen.

According to this embodiment, it is possible to easily transition from the screen on which the reservation information is displayed to the registration screen of the target vehicle.

4. According to the above embodiments, the maintenance system further comprises:

a storage control unit (101, S402) configured to cause a storage unit (102) to store a registered image (2042d) registered in the image registration frame on the registration screen and a customer information of the vehicle in association with each other.

According to this embodiment, the customer information and the registered image can be managed in association with each other.

5. According to the above embodiments, the maintenance system further comprises:

a generation unit (201, S302) configured to generate a report using the registered image.

According to this embodiment, it is possible to generate a report using the registered image.

6. According to the above embodiments, the maintenance system further comprises:

an image processing unit (101, S602) configured to perform image processing on the registered image registered on the registration screen; and

a determination unit (101, S603) configured to make a determination related to replacement of a consumable part based on an image processing result of the image processing unit.

According to this embodiment, a replacement determination of the consumable part can be made based on the registered image.

7. According to the above embodiments,

the storage control unit further causes the storage unit to store the registered image and the customer information and a determination result of the determination unit in association with each other.

According to this embodiment, the customer information, the registered image, and whether replacement of the consumable part is necessary or not can be managed in association with each other.

8. According to the above embodiments, the maintenance system further comprises:

a receiving unit (101, S801) configured to receive a browsing request for the registered image from a terminal device of a customer; and

a first transmitting unit (101, S802) configured to transmit the registered image stored in the storage unit to the terminal device of the customer based on reception of the browsing request by the receiving unit.

According to this embodiment, the registered image can be browsed from the terminal device of the customer.

9. According to the above embodiments, the maintenance system further comprises:

a receiving unit (101, S801) configured to receive a browsing request for replacement information of the consumable part from a terminal device of a customer; and

a second transmitting unit (S101, S802) configured to transmit the determination result stored in the storage unit to the terminal device of the customer based on reception of the browsing request by the receiving unit.

According to this embodiment, the determination result related to replacement of the consumable part can be browsed from the terminal device of the customer.

10. According to the above embodiments,

the determination result transmitted by the second transmitting unit includes information on a replacement time of the consumable part.

According to this embodiment, it is possible to prompt the customer to replace the consumable part at an appropriate replacement time.

11. According to the above embodiments,

the display control unit causes the display unit to display the registration screen having the image registration frame corresponding to a vehicle type of the vehicle and the maintenance content.

According to this embodiment, it is possible to display an appropriate registration screen according to the vehicle type and the maintenance content.

12. According to the above embodiments,

the maintenance content includes information on a maintenance category, and

the maintenance category includes at least one of a vehicle inspection and a legal inspection.

According to this embodiment, it is possible to display an appropriate registration screen for each maintenance category.

13. According to the above embodiments,

the maintenance content includes information on a target part of maintenance, and

the target part includes at least one of an engine, a vehicle interior, or an undercarriage.

According to this embodiment, it is possible to display an appropriate registration screen according to the target part of maintenance.

14. A maintenance method in the above embodiment comprises:

accepting (S203) a registration request for an image for a maintenance report of a vehicle; and

causing (S204) a display unit (204) to display a registration screen (2042) having an image registration frame (2042c) corresponding to a maintenance content based on acceptance of the registration request in the accepting.

According to this embodiment, because the registration screen having the image registration frame corresponding to the maintenance content is displayed, it is possible to efficiently create a maintenance report using an image.

15. A non-transitory storage medium in the above embodiment stores a program causing a computer to execute a method, the method comprising:

accepting (S203) a registration request for an image for a maintenance report of a vehicle; and

causing (S204) a display unit (204) to display a registration screen (2042) having an image registration frame (2042c) corresponding to a maintenance content based on acceptance of the registration request in the accepting.

According to this embodiment, because the registration screen having the image registration frame corresponding to the maintenance content is displayed, it is possible to efficiently create a maintenance report using an image.

The invention is not limited to the foregoing embodiments, and various variations/changes are possible within the spirit of the invention.

What is claimed is:

1. A maintenance system comprising:
a first acceptance unit configured to accept a registration request for an image for a maintenance report of a vehicle; and
a display control unit configured to cause a display unit to display a registration screen having an image registration frame corresponding to a maintenance content based on acceptance of the registration request by the first acceptance unit.

2. The maintenance system according to claim 1, further comprising:
a second acceptance unit configured to accept a maintenance reservation,
wherein the registration request is a request for a target vehicle of the maintenance reservation accepted by the second acceptance unit.

3. The maintenance system according to claim 2, wherein
the display control unit is capable of causing the display unit to display a reservation display screen including information on a plurality of the maintenance reservations accepted by the second acceptance unit,
the reservation display screen allows selection of one maintenance reservation from the plurality of the maintenance reservations, and
the registration request is a request for the target vehicle of the one maintenance reservation selected from the plurality of the maintenance reservations on the reservation display screen.

4. The maintenance system according to claim 1, further comprising:
a storage control unit configured to cause a storage unit to store a registered image registered in the image registration frame on the registration screen and a customer information of the vehicle in association with each other.

5. The maintenance system according to claim 4, further comprising:
a generation unit configured to generate a report using the registered image.

6. The maintenance system according to claim 4, further comprising:
an image processing unit configured to perform image processing on the registered image registered on the registration screen; and
a determination unit configured to make a determination related to replacement of a consumable part based on an image processing result of the image processing unit.

7. The maintenance system according to claim 6, wherein
the storage control unit further causes the storage unit to store the registered image and the customer information and a determination result of the determination unit in association with each other.

8. The maintenance system according to claim 4, further comprising:
a receiving unit configured to receive a browsing request for the registered image from a terminal device of a customer; and
a first transmitting unit configured to transmit the registered image stored in the storage unit to the terminal device of the customer based on reception of the browsing request by the receiving unit.

9. The maintenance system according to claim 7, further comprising:
a receiving unit configured to receive a browsing request for replacement information of the consumable part from a terminal device of a customer; and
a second transmitting unit configured to transmit the determination result stored in the storage unit to the terminal device of the customer based on reception of the browsing request by the receiving unit.

10. The maintenance system according to claim 9, wherein
the determination result transmitted by the second transmitting unit includes information on a replacement time of the consumable part.

11. The maintenance system according to claim 1, wherein
the display control unit causes the display unit to display the registration screen having the image registration frame corresponding to a vehicle type of the vehicle and the maintenance content.

12. The maintenance system according to claim 1, wherein
the maintenance content includes information on a maintenance category, and
the maintenance category includes at least one of a vehicle inspection and a legal inspection.

13. The maintenance system according to claim 1, wherein
the maintenance content includes information on a target part of maintenance, and
the target part includes at least one of an engine, a vehicle interior, or an undercarriage.

14. A maintenance method comprising:
accepting a registration request for an image for a maintenance report of a vehicle; and
causing a display unit to display a registration screen having an image registration frame corresponding to a maintenance content based on acceptance of the registration request in the accepting.

15. A non-transitory storage medium that stores a program causing a computer to execute a method, the method comprising:
accepting a registration request for an image for a maintenance report of a vehicle; and
causing a display unit to display a registration screen having an image registration frame corresponding to a maintenance content based on acceptance of the registration request in the accepting.
